(19) United States
(12) Patent Application Publication
(10) Pub. No.: US 2002/0170146 A1
(43) Pub. Date: Nov. 21, 2002

(54) Awning sheet manual extension system

(76) Inventor: Scott P. Thompson, Longmont, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 09/902,061

(22) Filed: Jul. 9, 2001

Related U.S. Application Data
(60) Provisional application No. 60/287,197, filed on Apr. 27, 2001.

(51) Int. Cl. B62B 1/00

(52) U.S. Cl. 16/444

(57) ABSTRACT

An awning sheet manual extension system includes a pull strap having a length and longitudinally spaced pockets. The strap includes two ends with one end being adapted for connection to a roll bar of an awning incorporating the pull strap. The system also includes a shaped pull rod having two end segments and at least one intermediate handle portion. At least one of the end segments of the rod is adapted for releasable connection with a free end of the strap. The pull strap is connected to the roll bar such that when the pull strap is pulled by the pull rod, the roll bar is causing to rotate thereby causing the awning sheet to unroll from the roll bar.

### CROSS-REFERENCE TO RELATED APPLICATION

This application claims the benefit of U.S. provisional application No. 60/287197, filed Apr. 27, 2001.

### BACKGROUND OF THE INVENTION

1. Field of the Invention

The present invention relates generally to retractable awnings and more particularly to a manual deployment system for moving the awning from a retracted position to an extended position.

2. Description of the Relevant Art

Retractable awnings have been in use for many years, with early uses being primarily as covers for windows, doors and the like. More recently, retractable awnings have been designed for use on mobile structures such as recreational vehicles and mobile homes, and, accordingly, out of necessity, the awnings have needed to include more sophisticated systems of operation and for retaining the awnings in either retracted or extended positions. Further, awnings for recreational vehicles and mobile homes are fairly long so as to extend along a substantial portion of the side of the vehicle, and, accordingly, they are relatively heavy and are sometimes difficult to manipulate.

In an effort to make deployment of the awning system easier, an automated awning system was developed and is disclosed in pending application Ser. No. 09/586,945, filed Jun. 2, 2000, for a Powered Retractable Awning, which is of common ownership with the present application and is hereby incorporated by reference in its entirety. The automated awning basically operates by having a motor that causes an awning roll bar to rotate in either direction thereby causing the awning sheet on the roll bar to either unroll and extend or roll and retract. While the automated awning overcomes problems inherent in other prior art systems, it is relatively expensive to manufacture due to the motorized automatic operation of the awning.

In an effort to create a lower cost deployment system that still overcomes the shortcomings of prior art systems, a subsequent manual deployment system with easier deployment features was developed and is disclosed in pending U.S. provisional application Serial No. 60/253180, filed Nov. 27, 2000, for an Easy Deployment Retractable Awning, which is of common ownership with the present application and is hereby incorporated by reference in its entirety.

The aforenoted Easy Deployment Retractable Awning is simply moved from its retracted to its extended position by pulling the awning roll bar away from the support surface causing the awning sheet to unwrap from the roll bar and the support arms and rafter arms to automatically deploy until the awning is fully extended. To pull the awning roll bar away from the support surface, one must manually grasp a pull-down strap on a center portion of the roll bar and pull downwardly causing the awning sheet to unwrap from the roll bar. However, both the height of the roll bar and the strength required to pull the roll bar downwardly are sometimes difficult tasks for the awning system user to undertake. The problem is further exacerbated by the fact that many recreational vehicles are owned and operated by elderly individuals who do not always have the strength of younger individuals, and many times the elderly have some difficulty in extending the awning.

Accordingly, means for more easily extending a retractable awning from its retracted position would be desirable in the retractable awning industry.

It is to overcome the shortcomings in prior art awning systems and to provide a dependable and easily undertaken means for extending a retractable awning that the present system has been developed.

### SUMMARY OF THE INVENTION

The present invention relates to a system for more easily extending a typical retractable awning that includes a roll bar about which an awning sheet or canopy can be wrapped with one edge of the awning sheet being secured to a supporting surface and the other edge to the roll bar. A pair of support arms and rafter arms are operably supported on the support surface and connected to the roll bar in a manner so as to permit the roll bar to move between a retracted position adjacent to the support surface and an extended position displaced from the support surface.

As the roll bar moves from the retracted to the extended position, the support arms automatically extend telescopically while the rafter arms unfold about an elbow member approximately midway along the length of the rafter arms. When the awning is fully deployed, it is retained in the extended position by lock mechanisms provided in the support arms and/or rafter arms.

The present invention in its preferred embodiment includes a pull strap having a length and plurality of loops or pockets along its length. The strap includes two ends, a free end and an end adapted for connection to the roll bar. The system also includes a shaped or pre-contoured pull rod having two end segments and at least one intermediate handle or gripping segment between the end segments. At least one of the end segments of the rod is adapted for releasable connection to the free end of the strap. The pull strap is connected to the roll bar such that when the pull strap is pulled by the pull rod, the roll bar is caused to rotate thereby allowing the awning sheet to unroll from the roll bar.

Other aspects, features, and details of the present invention can be more completely understood by reference to the following detailed description of the preferred embodiment, taken in conjunction with the drawings and from the appended claims.

### BRIEF DESCRIPTION OF THE DRAWINGS

FIG. 1 is a front isometric view of a recreational vehicle with an awning system in its retracted position and a user connecting one end of the present invention pull rod with one end of the present invention pull strap.

FIG. 2 is an enlarged cut-away view of the awning system awning sheet and the present invention pull strap and pull rod in FIG. 1.

FIG. 3 is an isometric view of a user with one hand on the end handle portion of the pull rod and a second hand on a second handle portion near the middle of the pull rod while the other end of the pull rod is connected with the pull strap (which is connected with the awning sheet roll).

FIG. 4 is an isometric view of a user with one hand on the handle portion near the middle of the pull rod and a second hand grasping a portion of one layer of the pull strap between the end of the strap and a first point where the strap layers are joined (the strap is connected with the awning sheet roll).

FIG. 5 is a front isometric view of a recreational vehicle with an awning system in its extended position and a user pulling a pull strap connected to the awning sheet roll of the awning system.

FIG. 6 is a section view taken along line 6-6 of FIG. 5.

FIG. 7 is a top plan view of the pull rod.

FIG. 8 is an enlarged front isometric view of the pull strap end that connects with the pull rod.

### DESCRIPTION OF THE PREFERRED EMBODIMENTS

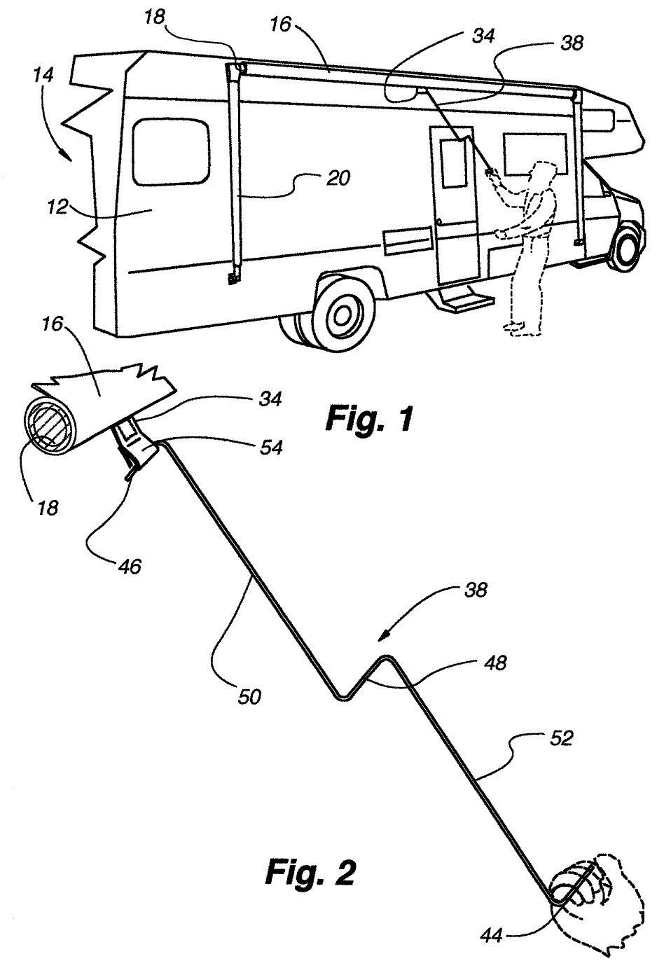

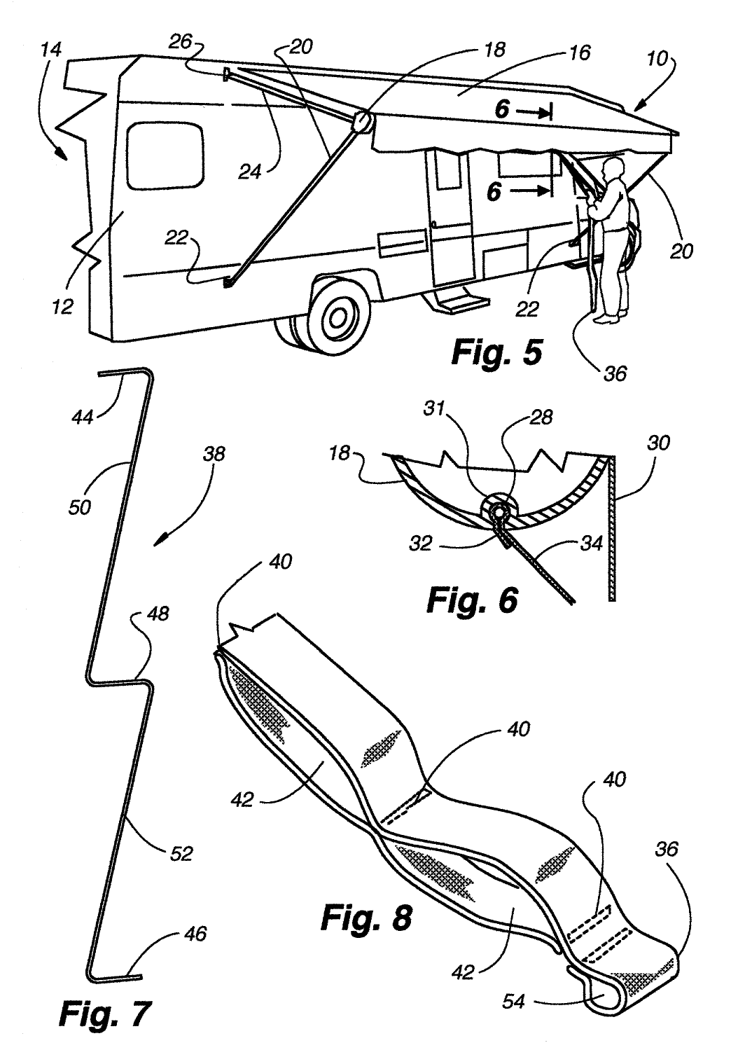

The system of the present invention finds usefulness in a retractable awning 10 of a type shown in FIGS. 1 and 5 mounted on the side 12 of a recreational vehicle 14 or other supporting surface. Awnings of this type are well known in the art with an example of such being described in U.S. Pat. No. 5,560,412, which is of common ownership with the present application and incorporated by reference herein. The awnings of this type include an awning sheet or canopy 16 that is secured along one edge to a supporting surface, such as the side wall 12 of the recreational vehicle or the like and an opposite edge which is secured to a roll bar 18 about which the canopy can be rolled when the awning is moved from an extended position (FIG. 5) to a retracted position (FIG. 1). The awning further includes a pair of support arms 20 having their outer ends rotatably connected to an associated end of the roll bar 18 and their inner ends pivotally mounted on support brackets adjacent to a lower edge of the side wall 12. The support arms are typically telescopic in construction so that the length thereof can be extended or retracted as the awning is moved between extended and retracted positions. A pair of rafter arms 24 also support opposite ends of the roll bar 18 with the rafter arms having an inner end secured to brackets 26 on the side wall 12 adjacent a top edge thereof. The rafter arms are typically collapsible such as with the use of an elbow joint or the like (not shown) at a mid-point along their length. The roll bar is typically a tubular member having a plurality of longitudinally extending circumferentially spaced recesses 28 (FIG. 6) formed in its outer surface with one of those recesses (not seen) receiving and securing the outer edge of the awning sheet, another recess (not seen) receiving an edge of a valance 30 and another recess 31 (FIG. 6) receiving one end 32 of a pull strap 34 utilized by an operator in moving the awning from the retracted position of FIG. 1 to the extended position of FIG. 5.

The connection of the pull strap 34 to the roll bar is best illustrated in FIG. 6 and as can be appreciated, when the awning is being retracted from the extended position of FIGS. 5 and 6 to the retracted position of FIG. 1, the pull strap is being wrapped around the roll bar along with the awning sheet 16 and valance 30 until the awning sheet, pull strap and valance are substantially fully wrapped around the roll bar 18. When fully retracted, the opposite or free end 36 of the pull strap is exposed slightly as seen in FIG. 2 so that an operator of the awning can grasp the free end of the pull strap and, by pulling the pull strap downwardly and outwardly, extend the awning from the retracted position of FIG. 1 to the extended position of FIG. 5. As can be appreciated, as the awning is being extended, the pull strap is unwrapped from the roll bar.

As might be appreciated, and as mentioned previously, awnings of this type are relatively heavy and can be cumbersome to operate particularly for elderly individuals. Accordingly, and in accordance with the present invention, the pull strap has been uniquely designed for cooperative use with a uniquely designed pull cane or rod 38.

The pull strap 34 has a length that is approximately the same as the depth of the awning sheet 16 and the strap may be made of an elongated strip of webbing or other non-elastic material which has been folded upon itself and stitched at 40, or otherwise secured transversely, at longitudinally spaced locations as shown in FIG. 8 to define a plurality of adjacent pockets 42 along the length of the strap. The strap of course could be formed in many other manners consistently with the present invention such as a single strip of webbing could have loops of webbing or other materials (not shown) secured thereto or formed therefrom defining pockets at spaced intervals along the length of the strap.

The pull rod or cane 38 is rigid and uniquely designed to have an outer end 44 adapted to be releasably connected to the pull strap, an inner end 46 adapted to be grasped by an operator of the awning and one or more intermediate gripping locations 48 (only one being illustrated) between the outer and inner ends of the pull rod. In the disclosed embodiment seen best in FIGS. 2 and 7, the outer and inner ends of the pull rod are relatively short segments and are parallel with each other and as illustrated are horizontally disposed when the rod is in use. The single intermediate gripping area or segment 48 of the pull rod is also parallel with the outer and inner segments and of approximately the same length. In between the outer segment and the intermediate gripping segment is a relatively long, straight outer connecting segment 50 that is disposed at an acute angle to the outer segment 44 and the gripping segment 48 and assumes approximately one-half of the overall length of the pull rod. An elongated, straight inner-connecting segment 52 extends from the inner end 46 of the rod to the intermediate gripping segment 48 so as to extend in parallel but longitudinally spaced relationship with the outer elongated connecting segment 50. As will be appreciated with the description of the operation of the device hereafter, the pull rod 38 could be made with more than one intermediate gripping segment 48 by repeating the same pattern with connecting segments as described.

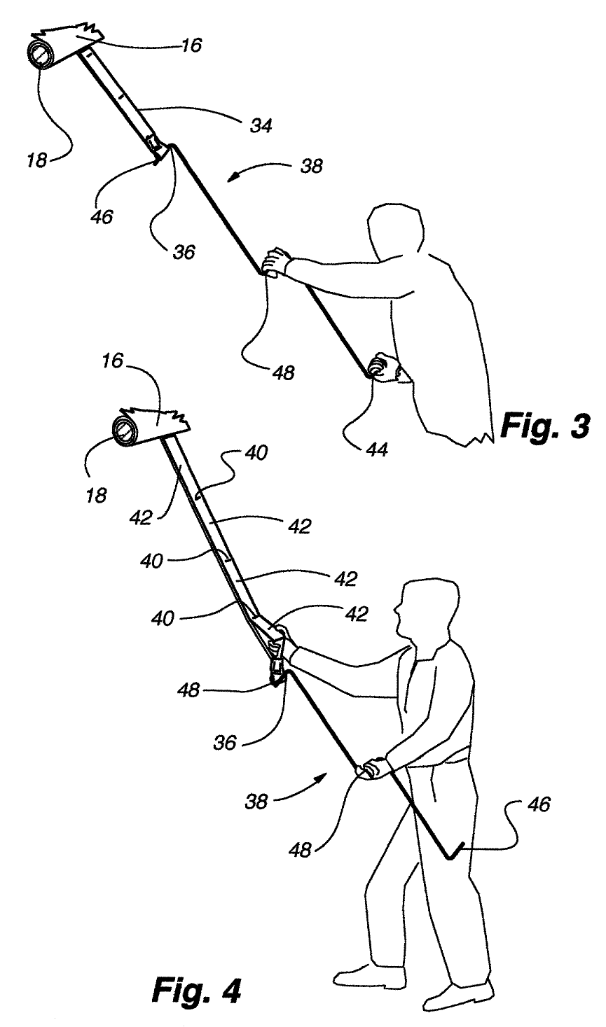

In operation, as shown in FIGS. 1-5, an operator of the system grips the inner segment 46 of the pull rod 38 and inserts the outer segment 44 of the pull rod into a loop 54 at the outer or free end 36 of the pull strap. The operator then pulls downwardly on the inner segment of the pull rod causing the awning and the pull strap to extend from the retracted position of FIG. 1 and after the pull strap has been partially extended along with the awning, the operator can use his other hand to grasp the intermediate gripping segment of the pull rod as shown in FIG. 3 and with further extension of the awning, the operators first hand can then be used to grip the free end 36 of the pull strap as in FIG. 4. From this position, the pull strap can be fully extended or unwrapped from the roll bar placing the roll bar in the position of FIGS. 5 and 6 and thereafter the awning can be locked in the extended position with conventional locks (not shown) on the support arms and/or rafter arms. The pull strap 34 can then be tucked between the roll bar 18 and the awning sheet 16 in an out of the way location or can be slid to one end or the other of the roll bar and draped over the adjacent rafter arm 24, for example, to keep the pull strap in an out of the way location.

It will be appreciated from the above that a system for deploying a retractable awning is simple in construction and easy to operate even for the elderly.

In other embodiments of the pull strap (not shown), the strap could be configured from three or more layers of material with loops or pockets configured on only the exterior layers of the material. In another embodiment, the pull strap could be configured from one layer of material with only portions of a second layer attached to the surface of the first layer to create handle loops or pockets. As one skilled in the art will realize, many different embodiments are possible that would enable the user to pull the pull strap without having to overreach or use elevation means.

Although a typical awning sheet manual extension system has been described with a certain degree of particularity, it is understood that the present disclosure has been made by way of example, and changes in detail or structure may be made without departing from the spirit of the invention as defined in the appended claims.

What is claimed is:

1. A system for extending an awning sheet stored on an awning roll bar from a retracted position to an extended position, said system comprising:
a pull strap having a length and including at least one pocket along said length, said strap including a first end adapted for operative connection with said bar roll and a second end; and
a pull rod having two end segments and including at least one intermediate gripping segment, at least one of said end portions adapted for reasonable connection with said second end of said strap.

2. The system of claim 1, wherein said pockets can be grasped by a user of the system.

3. The system of claim 1, wherein said rod is of a length sufficient to allow a user of average height standing on the ground to connect at least one of said rod end portions with said second end of said strap while said awning sheet is in said first retracted position.

4. A pull strap for extending an awning sheet stored on a roll bar from a retracted position to an extended position, said strap comprising:
a strip of material having a length, a first end adapted for connection with said roll bar and a second end opposite said first end said strip having at least one pocket formed along said length between said first and second ends.
a first end adapted for connection with said roll bar; and
a second end opposite said first end.

5. The pull strap of claim 4, wherein said pockets can be grasped by an individual extending said awning.

6. A shaped pull rod for extending an awning system pull strap from a first retracted position to an extended position, said rod comprising:
two end segments; and
at least one intermediate gripping segment adapted to be grasped by a hand of a user of the pull rod;
wherein at least one of said end segments is adapted for releasable connection to said pull strap.

7. The pull rod of claim 6 wherein said pull rod is elongated and wherein said end segments are substantially perpendicular to the length of said pull rod.

8. The pull rod of claim 7 wherein said at least one intermediate segment is substantially parallel to said end segments.

9. The pull rod of claim 8 further including connecting segments extending between said ends and said at least one intermediate segment.

10. The pull rod of claim 9 wherein said connecting segments form an acute angle with said end segments and said intermediate segments.
